(19) United States
(12) Patent Application Publication
(10) Pub. No.: US 2008/0152179 A1
(43) Pub. Date: Jun. 26, 2008

(54) Virtual sound effect device of remote control model

(76) Inventor: Jung-Pei Huang, Kaohsiung City (TW)

Correspondence Address: Jung-Pei Huang, 235 Chung - Ho, Box 8-24, Taipei, omitted

(21) Appl. No.: 11/645,344

(22) Filed: Dec. 26, 2006

(51) Int. Cl. H04R 1/02

(52) U.S. Cl. 381/334

(57) ABSTRACT

A virtual sound effect device of a remote control model comprises a signal receiving unit for receiving signals from a remote control emitter; the signal receiving unit being a replaceable plug in model, a central processing unit for identifying the class of receiving signals; a speech chip connected to the central processing unit for transmitting prerecorded sound after the central processing unit determining the class of the sound effect; the sound effect from the speech chip being replaceable; a small signal amplifying wire connected to the speech chip; the sound from the speech chip being amplified by the small signal amplifying wire; a stereo female terminal connected to the small signal amplifying wire and being a sound effect output terminal; and a battery set providing electric power to the signal receiving unit, the central processing unit, the speech chip and the small signal amplifying wire.

### FIELD OF THE INVENTION

The present invention relates to a virtual sound effect device of a remote control model which can provide virtual sound effect to a remote control devices, such as the sound effects of remote control cars, remote control boats, remote control helicopters, remote control airplanes, or a remote control toys, etc. or sound effects of speeding and barking.

### BACKGROUND OF THE INVENTION

Referring to FIG. 1, current remote control models, such as remote control cars, remote control boats, remote control helicopters, remote control airplanes, or a remote control toys, etc. emits signals to a remote control model for remotely controlling the remote control model to move in different directions, so that the user can enjoy the interest of remotely controlling an object. However, these devices have no virtual sound effect.

### SUMMARY OF THE INVENTION

Accordingly, the primary object of the present invention is to provide a virtual sound effect device of a remote control model which can provide virtual sound effect device to a remote control devices, such as the sound effects of remote control cars, remote control boats, remote control helicopters, remote control airplanes, or a remote control toys, etc. or sound effects of speeding and barking.

To achieve above objects, the present invention provides a virtual sound effect device of a remote control model comprises a signal receiving unit for receiving signals from a remote control emitter; the signal receiving unit being a replaceable plug in model, a central processing unit for identifying the class of receiving signals; a speech chip connected to the central processing unit for transmitting prerecorded sound after the central processing unit determined the class of the sound effect; the sound effect from the speech chip being replaceable; a small signal amplifying wire connected to the speech chip; the sound from the speech chip being amplified by the small signal amplifying wire; a stereo female terminal connected to the small signal amplifying wire and being a sound effect output terminal; and a battery set providing electric power to the signal receiving unit, the central processing unit, the speech chip and the small signal amplifying wire.

The various objects and advantages of the present invention will be more readily understood from the following detailed description when read in conjunction with the appended drawing.

### BRIEF DESCRIPTION OF THE DRAWINGS

FIG. 1 is a schematic view showing the application of the prior art.

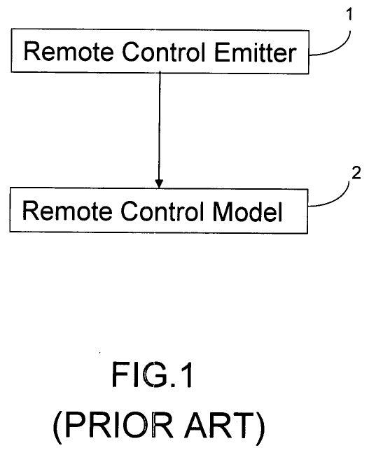

FIG. 2 shows the circuit block diagram of the present invention.

FIG. 3 is a schematic view showing the use of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

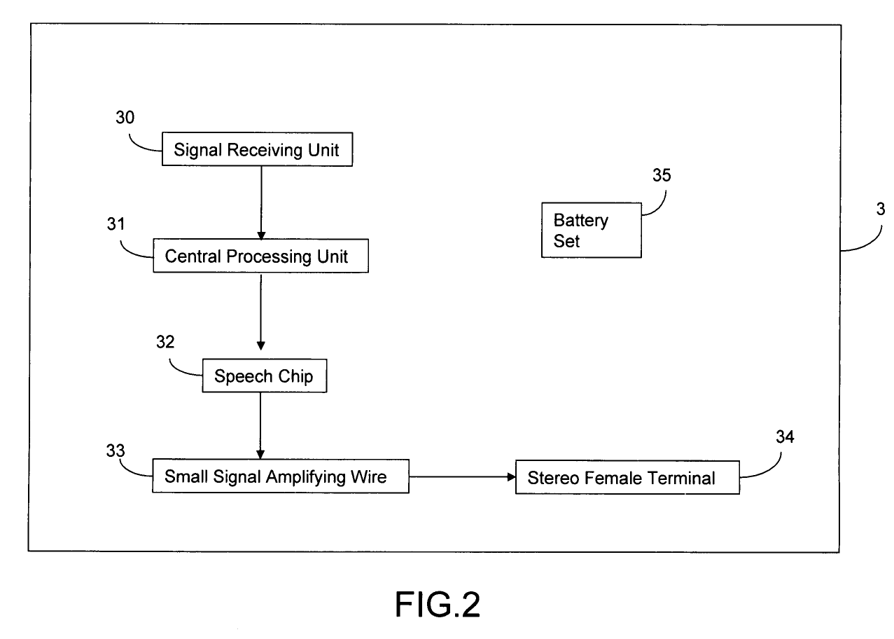

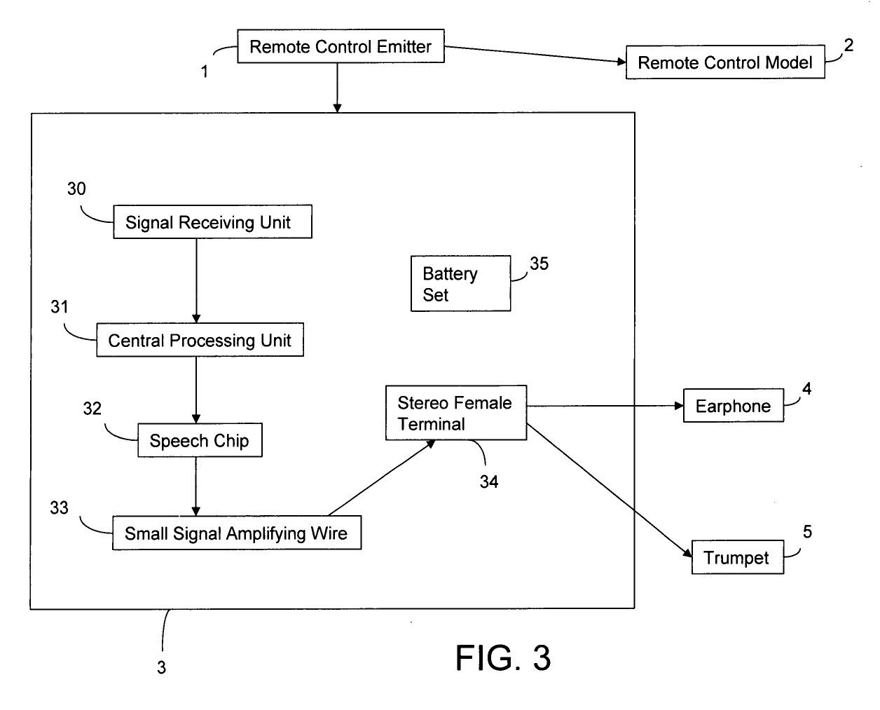

Referring to FIGS. 2 and 3, the virtual sound effect device 3 of a remote control model 2 of the present invention is illustrated. The remoter control module may be for example, a remote control car, a remote control boat, a remote control helicopter, a remote control airplane, or a remote control toy, etc. The virtual sound effect device 3 may be a wireless pocket device. The virtual sound effect device 3 is installed with a signal receiving unit 30 for receiving signals from a remote control emitter 1. The signal receiving unit 30 may be a replaceable plug in model, the plug in device of FM channels, AM channels, RF channels, GSM channels. A central processing unit 31 includes a self-study program, such as a neural net program. The central processing unit 31 serves for identifying the class of receiving signals. A speech chip 32 is connected to the central processing unit 31 serves for transmitting prerecorded sound after the central processing unit 31 determines the class of the sound effect. The sound effect from the speech chip 32 is replaceable, such as sound effects of cars, sound effect of helicopters, sound effect of boats, sound effect of airplanes. A small signal amplifying wire 33 is connected to the speech chip 32. The sound from the speech chip 32 is amplified by the small signal amplifying wire 33. A stereo female terminal 34 is connected to the small signal amplifying wire 33 and is a sound effect output terminal. The stereo female terminal 34 can be connected to an earphone 4 or a trumpet 5 for playing sound. A battery set provides electric power to the signal receiving unit 30, the central processing unit 31, the speech chip 32 and the small signal amplifying wire 33.

In operation, referring to FIG. 3, when the external remote control emitter 1 emits signals to the remote control model 2, the signal receiving unit 30 will transmit the signals to the central processing unit 31. Then the central processing unit 31 determines the class of the sound effect and then the speech chip 32 emits corresponding sounds. Then the small signal amplifying wire 33 amplifies the sounds from the speech chip 32. Finally, the amplified sounds are transmitted to the earphone 4 or trumpet 5 for being outputted. The sound effect is selectable, such as sounds of remote control cars, remote control boats, remote control helicopters, remote control airplanes, or a remote control toys, etc. or the sound of speeding and braking.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A virtual sound effect device of a remote control model comprising:
a signal receiving unit for receiving signals from a remote control emitter; the signal receiving unit being a replaceable plug in model,
a central processing unit for identifying the class of receiving signals;
a speech chip connected to the central processing unit for transmitting prerecorded sound after the central processing unit determining the class of the sound effect; the sound effect from the speech chip being replaceable;
a small signal amplifying wire connected to the speech chip; the sound from the speech chip being amplified by the small signal amplifying wire;
a stereo female terminal connected to the small signal amplifying wire and being a sound effect output terminal; and
a battery set providing electric power to the signal receiving unit, the central processing unit, the speech chip and the small signal amplifying wire.

2. The virtual sound effect device of a remote control model as claimed in claim 1, wherein the virtual sound effect device is a wireless pocket-size device.

3. The virtual sound effect device of a remote control model as claimed in claim 1, wherein the signal receiving unit is a replaceable plug-in device and the plug-in device is one of device of FM channels, AM channels, RF channels, GSM channels.

4. The virtual sound effect device of a remote control model as claimed in claim 1, wherein the remote control emitter emits signals to the signal receiving unit and the remote control module.

5. The virtual sound effect device of a remote control model as claimed in claim 1, wherein the remoter control module is one of a remote control car, a remote control boat, a remote control helicopter, a remote control airplane, and a remote control toy.

6. The virtual sound effect device of a remote control model as claimed in claim 1, wherein the central processing unit including a self-study program.

7. The virtual sound effect device of a remote control model as claimed in claim 1, wherein the remote control module has the sound effects of at least one of racing cars, helicopters, boats, and airplanes.

8. The virtual sound effect device of a remote control model as claimed in claim 1, wherein the stereo female terminal is connected to one of an earphone and a trumpet for playing sound.
